(19) United States
(12) Patent Application Publication
(10) Pub. No.: US 2016/0376952 A1
(43) Pub. Date: Dec. 29, 2016

(54) EXHAUST RESONATOR FOR A TWO-STROKE ENGINE FOR USE IN A MOTORIZED FLOAT

(71) Applicant: Martin Sula, Brno (CZ)

(72) Inventor: Martin Sula, Brno (CZ)

(21) Appl. No.: 15/192,989

(22) Filed: Jun. 24, 2016

(30) Foreign Application Priority Data
Jun. 26, 2015 (CZ) CZ2015-31266 U

(51) Int. Cl. F01N 1/08; G10K 11/16; F02B 75/02

(52) U.S. Cl. CPC F01N 1/089; F02B 75/02; F01N 1/084; G10K 11/161; F02B 2075/025

(57) ABSTRACT

An exhaust resonator comprises a first cover having an inlet. A first end of a stabilizer tube is connected to the inlet. A second end of the stabilizer tube aims at a primary reflection surface at a first end of an expansion cone surrounding the stabilizer tube to define a first expansion space. A second end of the expansion cone aims at a secondary reflection surface inwardly of a first cover. A first end of an outer case surrounds the expansion cone. A second end of the outer case connects to a second cover that is provided with the outlet. A second expansion space is defined by the expansion cone and the outer case. The second expansion space is terminated by a baffle with an opening on an interface between the outer case and the second cover. The first cover is provided with at least one coolant liquid opening.

### FIELD OF THE INVENTION

The present invention relates to the adjustment of a tuned exhaust resonator for a two-stroke combustion engine for use in a motorized float.

### BACKGROUND OF THE INVENTION

The exhaust systems for two-stroke engines must comply with the requirements for the appropriate characteristics of torque moment, low noise level, and reduction of exhaust emissions. In addition, the exhaust systems used in motorized floats are required to be lightweight, compact, and with a lower operating temperature compared to standard exhaust systems of that type. Therefore, the use of the correct material for production of the exhaust system is the decisive factor as well as, and particularly, the shape of the resonator design, which directly affects the pressure in the exhaust port of the engine cylinder, and therefore engine performance by proper charging, as well as the emissions of the two-stroke engine that impact the environment.

Both the mass pulsation of the cylinder-exhaust resonator system and the pressure wave reflection that travel from the exhaust port after it is open occur in the exhaust resonator. Maximum efficiency is achieved when the duration of both actions is either identical or almost identical. Therefore, the duration of the period and the characteristics of the reflected pressure wave in the exhaust resonator have a decisive impact on the performance parameters of the engine. The ideal scenario for the pressure characteristics occurs in the exhaust port at resonance revolutions, i.e. at the moment of the highest torque of the engine. In the exhaust resonator design, the shape of the resonator should be designed so that the best approach to the pressure characteristics is achieved due to the proper pressure wave reflection.

The required resonance length of the exhaust resonator depends on the resonation revolutions of the engine. For example, the resonance length of the exhaust resonator equals 810 mm for resonance revolutions of 7700 revs/minute. For the use of the exhaust resonator in the motorized float with restricted spatial conditions, the placement of this type of resonator is very difficult and inconvenient.

Any disadvantage is avoided by bending the exhaust resonator so that the pressure characteristics of the exhaust gases are impaired as little as possible. The bending distance from the engine exhaust port also depends on the request for identical periods. Despite the fact that the efficiency of the bent exhaust resonator is always slightly lower compared to an ideal non-bent exhaust resonator, appropriate shaping makes the bent resonator almost as effective as the non-bent exhaust resonator.

However, the design of the bent exhaust resonator requires greater strength due to the increased stress applied to all the structural components of the exhaust resonator. The walls of the structure should be thicker in addition to the requirement for a larger number of connection components. Nevertheless, these essential conditions increase the weight of the exhaust resonator, which means that total weight of the float is higher at the expense of float portability, load capacity of the float, maximum float speed, and general comfort and user experience.

In addition, a more complex design requires more demanding production technology, and the use of more expensive and specially shaped components. Therefore, low costs are the next requirement for production of the exhaust systems.

U.S. Pat. No. 3,462,947 (A) discloses an exhaust system that is bent once. The system comprises a cylinder-shaped chamber consisting of a single functional reflection surface in the rear part of the cylinder. The exhaust tube in the chamber terminates in an expansion space and brings the exhaust gases to the first reflection surface. Upon reflecting, the exhaust gases flow to the successively narrowing compression space so that at its narrowest diameter the compression space surrounds the cone-shaped expansion space, wherein the compression space end has a constant diameter. Furthermore, the exhaust gases flow through a system of two baffles to the outlet outside the exhaust system. Although the exhaust system has a shorter structural length compared to standard exhaust systems, it is not short enough for use in the motorized floats. All the disadvantages mentioned above including the missing comfort and user experience, which is the basis for the use of the float, are incorporated due to the robust design and heavier weight.

U.S. Pat. No. 4,348,862 describes several embodiments of the two-stroke engine exhaust system. One embodiment of the invention shows a primary space with a divergent followed by a convergent portion (in the exhaust gas flow direction) pneumatically connected to the secondary expansion space. The exhaust gases reflect from the corrugated reflection surface at the beginning of the secondary expansion space and initially form a tube shape with a constant diameter followed by the divergent portion. Upon reflecting from the second reflection surface, the exhaust gases in this space terminate in the space surrounded by an outer cone-shaped case. The space is further narrowed into a circular opening leading to an integrated muffling chamber that reduces noise, and to the outlet outside the exhaust system. Two overpressure waves are generated in the system described and these return back to the engine cylinder the first in the convergent portion of the primary space and the second following the reflection of the exhaust gases from the circular opening of the narrowed portion of the outer case. Although it is claimed that the embodiment of the exhaust system substantially reduces the real length with respect to the effective length of the system, the one described therein does not provide the compactness needed for integration into the float. In addition, up to two overpressure waves occur instead of a single wave.

### SUMMARY OF THE INVENTION

The disadvantages mentioned above are resolved by the design of the exhaust resonator for the two-stroke engine according to this embodiment, in that it consists of the first cover of the exhaust resonator provided with the inlet, wherein the first end of the stabilizer tube connects to the inlet, and the other end aims at the primary reflection surface to which the first end of the expansion cone surrounding the stabilizer tube, and thereby defining the first expansion space, connects, wherein the other end of the expansion cone aims at the first cover inwardly provided with the secondary reflection surface, to which the first end of the outer housing of the exhaust resonator surrounding the expansion cone connects, wherein the other end of the exhaust resonator case connects to the other cover provided with the outlet, wherein the other expansion space defined by the expansion cone and case is terminated by the baffle with at least one opening on the interface between the case and the second cover, and wherein the first cover is provided with at least one coolant liquid opening.

The essence of the embodiment consists in the design of the exhaust resonator that uses the functional reflection surfaces for reversing the exhaust gas flow direction and thereby for the compactness of the whole exhaust system while retaining its resonant properties. The resonator is made from light metal alloys and/or composite materials to reduce the weight of the exhaust system, and therefore uses effective cooling for the use of these materials.

The stabilizer tube is the first component that the exhaust gas flows through following the entry through the inlet. Preferably, the tube has an identical diameter across its full length and is used to stabilize the overpressure waves outgoing from the engine. Such stabilization is needed for an improved characteristics of the pressure waves yet before the first impact on the primary reflection surface, and before coming back to the engine cylinder.

Following the flow through the stabilizer tube, the exhaust gas flow impacts on the primary reflection surfaces used for the exhaust gas reversing. These reflection surfaces have a shape that guarantees minimum energy loss in the exhaust gas reflection.

Another portion through which the exhaust gases flow is the first expansion space between the stabilizer tube and the flared expansion cone. The expansion cone in combination with the stabilizer tube is used for expansion of the space in the exhaust gas flow to increase the volume, and thereby to generate the negative pressure wave. The negative pressure wave with pressure lower than outer atmospheric pressure propagates back to the engine and assists in the aspiration of more fuel mixture into the engine cylinder.

The exhaust gases impact on the secondary reflection surfaces used for the second exhaust gas flow reversing after the flow through the first expansion space. Again, these reflection surfaces have a shape that guarantee minimum energy loss in the exhaust gas reflection.

The exhaust gas flow flows through the second expansion space consisting of the outer portion of the expansion cone and the exhaust resonator wall after reflecting from the secondary reflection surfaces. Again, the combination of the two components ensures the expansion of the exhaust gas flow resulting in reducing the pressure flow.

A baffle with at least one opening is provided at the end of the second expansion space. The baffle is used to produce the overpressure wave, which returns back to the engine after the reflection, and assists in pushing the leaked fuel back to the engine cylinder. Hence, better fuel economy, lower emissions, and improved engine performance are provided. The openings in the baffle are then used for the exhaust gas to flow through the baffle to the space behind the baffle from which it then flows to the integrated noise muffler through a connection tube.

The secondary reflection surface is provided with at least one cooling opening with a nozzle used for the water supply to the first expansion space. The water supply makes cooling of the exhaust gases highly effective because the full thermal capacity of the water is used, and the water turns into steam when in contact with the exhaust gases, and the steam flows with the exhaust gases through the next portions of the exhaust system, and then out of the exhaust system. In addition, water is also injected to a place where it significantly cools the secondary reflection surface, primary reflection surface, and especially the stabilizer tube, which is subject to the exhaust gases with the highest temperature exiting directly from the engine. In addition, the injection of water directly into the exhaust gases reduces the noise emanating from both the exhaust resonator and the exhaust system as a whole. The cooling system is thereby more efficient in contrast to the standard cooling of the exhaust resonator case where the full thermal capacity of the water remains largely unused. In addition, the effective cooling of the inner, hottest portions of the exhaust resonator is impossible with the cooling of the case.

The maximum temperature occurring inside the exhaust resonator is thereby decreased significantly in the use of the effective cooling. The light metal alloys and/or composite materials may thereby be used, which results in a significant weight drop in the exhaust system and the float as a whole.

In addition, the exhaust resonator according to this favourable embodiment contains only one expansion cone (the outer case and the stabilizer tube have a cylinder-like shape) with the most expensive production costs of all components for the exhaust resonator. A conventional exhaust resonator for a two-stroke engine contains two expansion cones. Production of the proposed exhaust resonator is cheaper compared to a conventional exhaust resonator.

The provided embodiment deals with the bending of the exhaust system resonator while retaining the main features of the resonator and while using the float for the purpose intended, and where such a way of use has been considerably limited so far. The way of use refers to its good portability, high operation loading capacity, sufficient maximum speed, excellent comfort and experience in use. This embodiment makes the way of use possible.

### SUMMARY OF DRAWINGS IN THE FIGURES

The attached figures illustrate:

FIG. 1—A cross section of the exhaust resonator including arrows indicating the direction of the exhaust gas flow, and identification of the inlet and outlet.

FIG. 2a—Individual components of the disassembled compact exhaust resonator.

FIG. 2b—Standard exhaust resonator.

FIG. 3a—Outer case.

FIG. 3b—Stabilizer tube.

FIG. 3c—Expansion cone.

FIG. 3d—A cross section of the compact resonator.

FIG. 4a—A detailed view of the first cover with the secondary reflection surface.

FIG. 4b—A detailed view of the second cover with the primary reflection surface.

### EXAMPLE EMBODIMENTS OF THE INVENTION

FIG. 1 illustrates a cross section of the exhaust system according to this embodiment. The inlet 1 is provided on the first cover of the exhaust resonator and the first end of the stabilizer tube 2 connects to the inlet. The stabilizer tube 2 has an elongated cylinder shaped case, and its other end is aimed at the primary reflection surface 3 arranged near the cover of the exhaust resonator. The first end of the flared expansion cone 4 surrounding the stabilizer tube 2 thus defining the first expansion space connects to the outer edges of the primary reflection surface 3 in the direction back to the first cover. The second end of the expansion cone 4 aims back at the outer edge of the first cover inwardly provided with the secondary reflection surface 5, to which the first end of the outer cylinder case 6 of the exhaust resonator surrounding the expansion cone 4 connects. The other end of the exhaust resonator case connects to the second cover of the exhaust resonator fitted with the outlet 7, wherein the second expansion space defined by the expansion cone 4 and the case 6 is terminated by the baffle with at least one opening on the interface between the case 6 and the second cover 7, and wherein the first cover is provided with at least one opening. Further, the first cover of the exhaust resonator is provided with the inlet 8 for coolant liquid. The arrows in the figure identify the direction of the flow of exhaust gas through the resonator.

The components of the exhaust resonator are made from light metal alloys and/or composite materials. This is due to intensive cooling with the use of the cooling liquid, usually water, injected into the exhaust gas flow, resulting in a significant reduction in the weight of the exhaust system and the float as a whole.

The operation of the exhaust resonator is as follows. The exhaust gas flows through the stabilizer tube used to stabilize the overpressure wave exiting from the engine after flowing through the inlet. Following the flow through the stabilizer tube, the exhaust gas flow impacts on the primary reflection surfaces used for reversing the exhaust gas. These primary reflection surfaces guarantee minimum energy loss in the exhaust gas reflection to avoid any hindering by the continuous flow of the gases. The exhaust gases then flow through the first expansion space defined by the stabilizer tube and the flared expansion cone. Here, the expansion cone serves for expansion of the space during the exhaust gas flow to increase its volume, and thereby to develop the negative pressure wave that assists in the aspiration of the fuel to the engine cylinder. The cooling opening with the nozzle terminates in the first expansion space to supply the cooling water to cool down the secondary reflection surface, primary reflection surface, and in particular the stabilizer tube that is in contact with the hottest exhaust gases emanating directly from the engine. In addition, the injection of water directly into the exhaust gases reduces the noise coming from both the exhaust resonator and the exhaust system as a whole. The exhaust gases impact on the secondary reflection surfaces used for reversing the second exhaust gas flow after flowing through the first expansion space. Again, these reflection surfaces have a shape that guarantees minimum energy loss in the exhaust gas reflection. The exhaust gas flow flows through the second expansion space defined by the outer portion of the expansion cone and the exhaust resonator wall after reflecting from the secondary reflection surfaces. Here, the exhaust gas flow expands again, and the pressure reduces. At the end of the second expansion space a baffle is provided with at least one opening used to generate the overpressure wave that is returned following the reflection back to the engine, and assisting in pressing the leaked gas back to the engine cylinder. The exhaust gases flowing through the baffle flow into the space behind the baffle from where they continue through the outlet in the second cover outside the exhaust resonator. For example, an integrated noise muffler etc. may be installed behind the exhaust resonator using a connection tube.

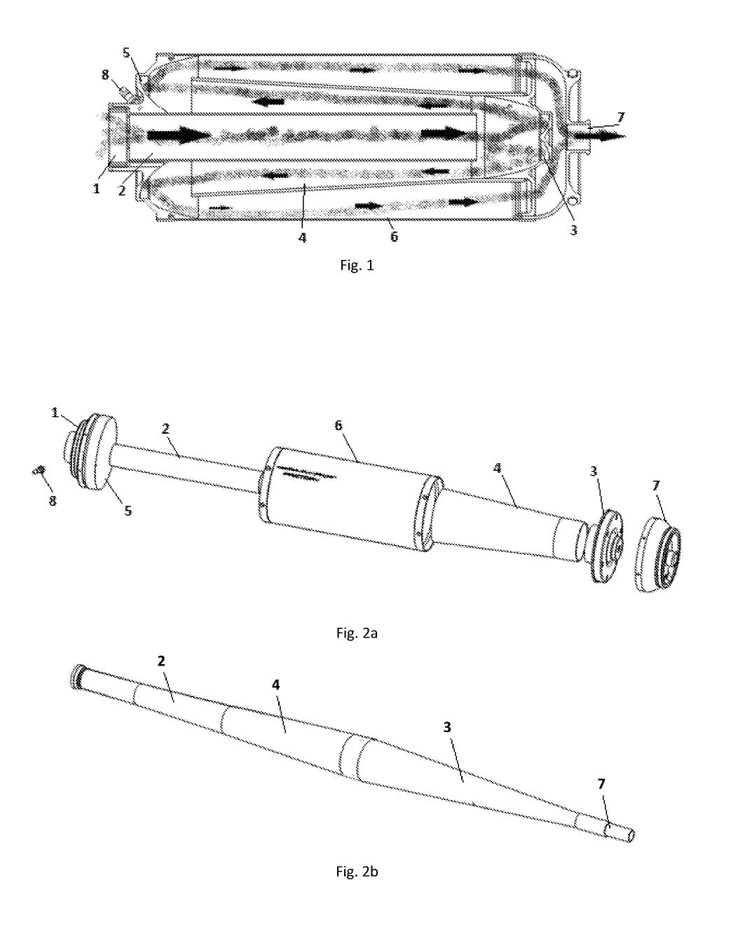

FIGS. 2a and 2b schematically illustrate the comparison of each component of the compact and standard exhaust resonator. The exhaust resonator according to the embodiment of this invention is shown in an exploded view in FIG. 2a. The first end of the stabilizer tube 2 connects to the inlet 1 in the first cover of the exhaust resonator. The exhaust gases then expand in the expansion space defined by the expansion cone 4. In the case of the exhaust resonator according to the embodiment of this invention, the expansion continues in the second expansion space defined by the outer cylinder-like case 6 surrounding the expansion cone 4. The baffle 9 with at least one opening 10 for generating the return overpressure wave is provided at the other end of the expansion space. With the standard exhaust resonator according to FIG. 2b exhaust gas flows initially through the stabilizer tube 2 and then, the overpressure wave is generated in the reflection cone member 3 linked to the expansion cone 4. The exhaust gases then leak from the exhaust resonator through the outlet 7. Further, the first cover of the exhaust resonator according to the present embodiment is provided with the inlet 8 for coolant liquid.

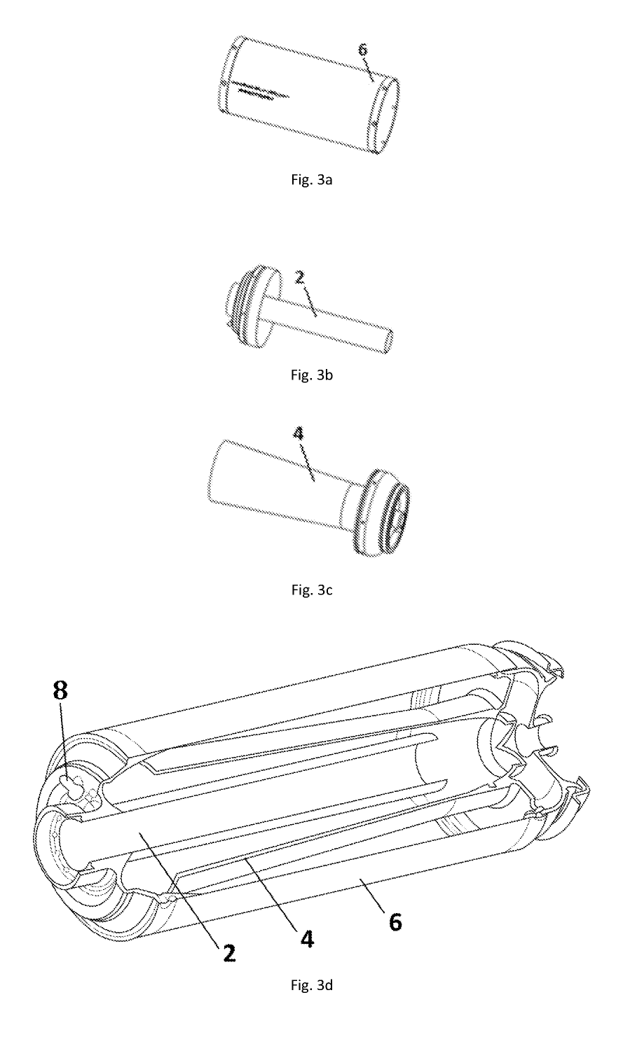

Three basic design components of the compact resonator are shown in FIGS. 3a, 3b and 3c. FIG. 3a illustrates outer cylinder case 6, FIG. 3b illustrates the stabilizer tube 2 and FIG. 3c illustrates the expansion cone 4 while FIG. 3d shows all of these three components in an assembled state. A coolant liquid nozzle 8 is located on the inlet side of the compact exhaust resonator.

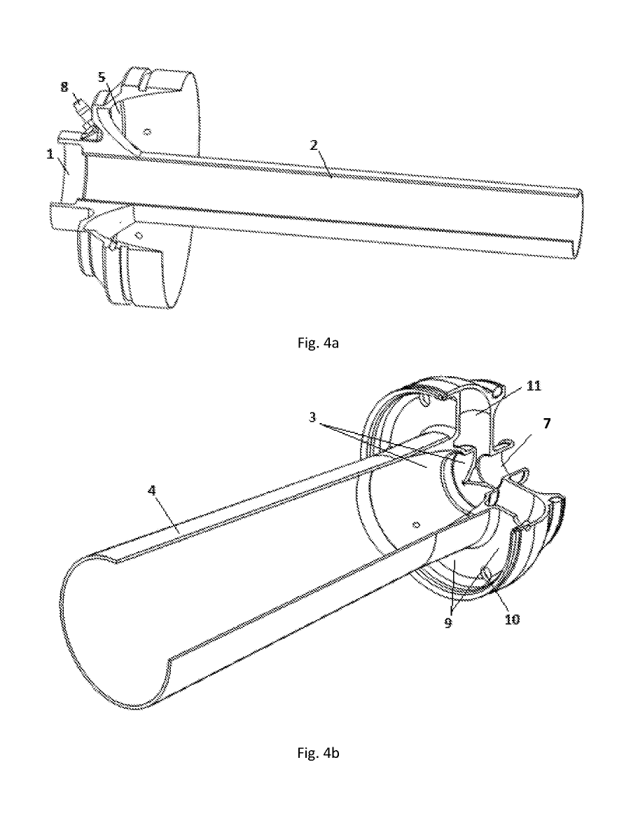

FIG. 4a shows the secondary reflection surface 5 in detail and FIG. 4b shows the primary reflection surface 3. Provided at the end of the second expansion space is the baffle 9 with at least one opening 10 through which the exhaust valves flow to the space behind the baffle 11 and exit the exhaust resonator through the outlet 7 in the second cover, and may continue to flow e.g. to the noise muffler, etc. Provided in the secondary reflection surface 5 is at least one cooling opening with a nozzle 8 that cools down the secondary reflection surface 5, the primary reflection surface 3 and the stabilizer tube 2 at the same time.

### INDUSTRIAL APPLICABILITY

The exhaust resonator for the two-stroke engine according to the present embodiment is particularly applicable in the motorized floats and related applications where requests for total low weight apply, i.e. for portability, high operation loading capacity, sufficient maximum speed, and in general, high comfort and an excellent user experience.

### LIST OF REFERENCE MARKS

1 Inlet
2 Stabilizer tube
3 Primary reflection surface
4 Expansion cone
5 Secondary reflection surface
6 Outer case
7 Outlet
8 Coolant liquid nozzle
9 Baffle
10 Baffle openings
11 Space behind the baffle

1. An exhaust resonator for a two-stroke engine, the exhaust resonator comprising a first cover having an inlet, stabilizer tube having a first end connected to the inlet, the stabilizer tube having a second end is aimed at a primary reflection surface (3) to which a first end of an expansion cone connects, the expansion cone surrounding the stabilizer tube, and thereby defining a first expansion space, wherein a second end of the expansion cone aims at the first cover, which is inwardly provided with a secondary reflection surface, to which a first end of an outer case is connected, the outer case surrounding the expansion cone, wherein a second end of the outer case connects to a second cover having an outlet, wherein a second expansion space is defined by the expansion cone and the outer case, wherein the second expansion space is terminated by a baffle with at least one opening on an interface between the outer case and the second cover, and wherein the first cover is provided with at least one coolant liquid opening.

2. The exhaust resonator for the two-stroke engine according to claim 1 being produced from light metal alloys and/or composite materials.

3. The exhaust resonator for the two-stroke engine according to claim 1, wherein the stabilizer tube has a substantially identical diameter across a full length thereof.

4. The exhaust resonator for the two-stroke engine according to claim 1, wherein the wall of the exhaust resonator is cylinder shaped.
